(19) United States
(12) Patent Application Publication
(10) Pub. No.: US 2024/0388409 A1
(43) Pub. Date: Nov. 21, 2024

(54) CONDITIONAL CARRIER AGGREGATION ASSOCIATED WITH REDUCED INTERRUPTION TIME IN MOVING NETWORKS

(71) Applicant: InterDigital Patent Holdings, Inc., Wilmington, DE (US)

(72) Inventors: Oumer Teyeb, Montreal (CA); Dylan Watts, Montreal (CA)

(73) Assignee: InterDigital Patent Holdings, Inc., Wilmington, DE (US)

(21) Appl. No.: 18/694,151

(22) PCT Filed: Sep. 29, 2022
(86) PCT No.: PCT/US2022/045173

§ 371 Date: Mar. 21, 2024

Related U.S. Application Data
(60) Provisional application No. 63/249,822, filed on Sep. 29, 2021.

(51) Int. Cl. H04L 5/00; H04B 17/382

(52) U.S. Cl. CPC H04L 5/0057; H04B 17/382; H04L 5/001; H04L 5/0082

(57) ABSTRACT

Systems, methods, and instrumentalities are disclosed herein associated with receiving a triggering configuration for starting and/or stopping a dual connection with a cell (e.g., second cell), where the triggering configuration may be the same or different for the uplink (UL) and downlink (DL). A configuration may be received regarding the WTRU UL behavior for faster activation of the target cell (e.g. faster channel quality indicator (CQI) reporting prior to starting the connection towards the second cell), which may include triggering conditions for starting the UL signaling. The triggering conditions may be monitored for starting the UL signaling towards/regarding the second cell for faster activation. In examples the triggering conditions may be monitored for starting the connection towards the second cell.

### CROSS-REFERENCE TO RELATED APPLICATIONS

This application claims the benefit of U.S. Provisional Application No. 63/249,822, filed Sep. 29, 2021, the contents of which are incorporated by reference herein.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE). Wireless communication devices may establish communications with other devices and data networks, e.g., via an access network, such as a radio access network (RAN).

### SUMMARY

Systems, methods, and instrumentalities are disclosed herein associated with conditional carrier aggregation (CA) associated with reduced interruption time in moving networks. A wireless transmit receive unit (WTRU) may be associated with a first cell. In examples, the WTRU may send channel quality information (CQI) reports associated with the first cell. The WTRU may receive information that indicates triggering conditions associated with starting a CA operation with the first cell and a second cell. The triggering conditions may include one or more of the following: a time condition, a timing advance condition, a time/frequency pre-compensation condition, a location condition, or a signal level threshold. The WTRU may determine that the triggering conditions have been met. Based on the determination that the triggering conditions have been met, the WTRU may send, via the first cell, CQI reports associated with the second cell. The CQI reports associated with the second cell may be sent more frequently than the CQI reports associated with the first cell. Based on the determination that the triggering conditions have been met, the WTRU may start the CA operation. During the CA operation, a connection with the first cell may be maintained and a connection with the second cell may be initiated. A first action via the first cell may be performed and a second action via the second cell may be performed. The first action may be associated with the second action.

Receiving triggering configuration information (e.g., information that indicates triggering conditions) associated with starting and/or stopping a dual connection (e.g., a CA operation) with a cell (e.g., second cell) may be provided, where the triggering configuration may be the same or different for the uplink (UL) and downlink (DL). Configuration information may be received regarding the WTRU UL behavior to use in associated with activation of the target (e.g., second) cell (e.g., for CA operation). For example, the configuration information may configure the WTRU to facilitate faster activation of the target cell (e.g., faster channel quality indicator (CQI) reporting prior to starting the connection towards the second cell), where in examples CQI reporting associated with the target cell (e.g., second cell) may be faster than CQI reporting associated with the source cell (e.g., first cell). The configuration information may include triggering conditions for starting the UL signaling (e.g., the faster CQI reporting). The triggering conditions may be monitored for starting the UL signaling towards and/or regarding the second cell for faster activation. In examples, the triggering conditions may be monitored for starting the connection towards the second cell.

In examples, if the one or more triggering conditions for starting the UL signaling towards and/or regarding the second cell for faster activation are (e.g., determined to be) satisfied (e.g., met), one or more of the following may apply. The UL signaling may start for faster activation (e.g., faster or more frequent CQI reporting) of the second cell. The WTRU location may be updated (e.g., for facilitating timing advance (TA) pre-compensation calculation towards the second cell).

In examples, if the one or more conditions for establishing the connection to the second cell are (e.g., determined to be) satisfied (e.g., met), one or more of the following may apply: start monitoring the physical downlink control channel (PDCCH) of the first and/or second cell for DL data and/or UL grants regarding the second cell (e.g., maintain a connection to the first cell while initiating a connection with the second cell), send and/or receive (e.g., data) based on UL and/or DL network scheduled resources to/from the first and second cells, or start monitoring terminating triggering conditions for stopping the connection to the first cell (e.g., for the WTRU to disconnect from the first cell, for example, stopping the CA operation).

In examples, if the one or more terminating triggering conditions for releasing (e.g., disconnecting from) the first cell are (e.g., determined to be) satisfied (e.g., met), one or more of the following may apply: terminate the connection with (e.g., disconnect from) the first cell (e.g., stop monitoring the PDCCH of the first cell, stop sending any UL data or scheduling request (SR) towards the first cell, etc.) or operate the connection with the second cell (e.g., only with the second cell, for example, stopping the CA operation).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 shows an example of different interfaces in a non-terrestrial network (NTN).

FIG. 3 shows an example Integrated Access and Backhaul (IAB) User Plane.

FIG. 4 shows an example IAB Control Plane.

FIG. 5 shows example inter-satellite mobility associated with an NTN WTRU.

FIG. 6 shows example inter-satellite mobility associated with an IAB node.

FIG. 7 shows an example multiple connection to both satellite cells to minimize service interruption time.

### DETAILED DESCRIPTION

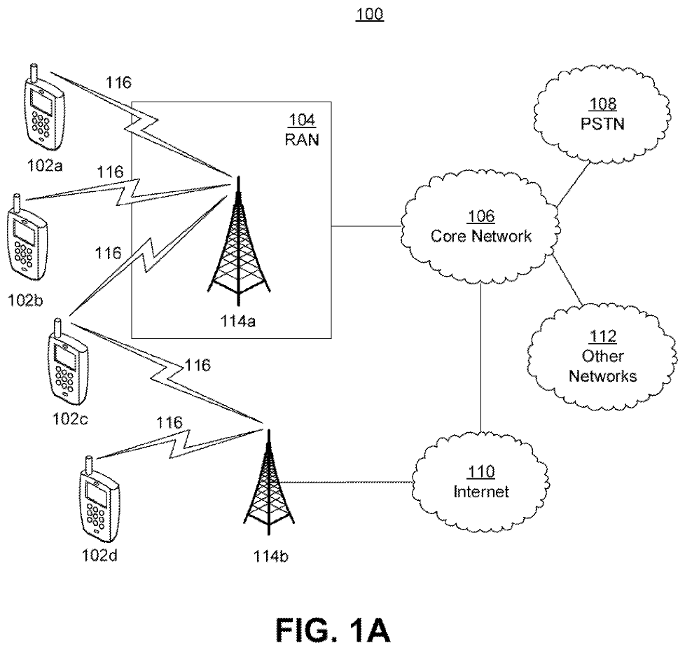

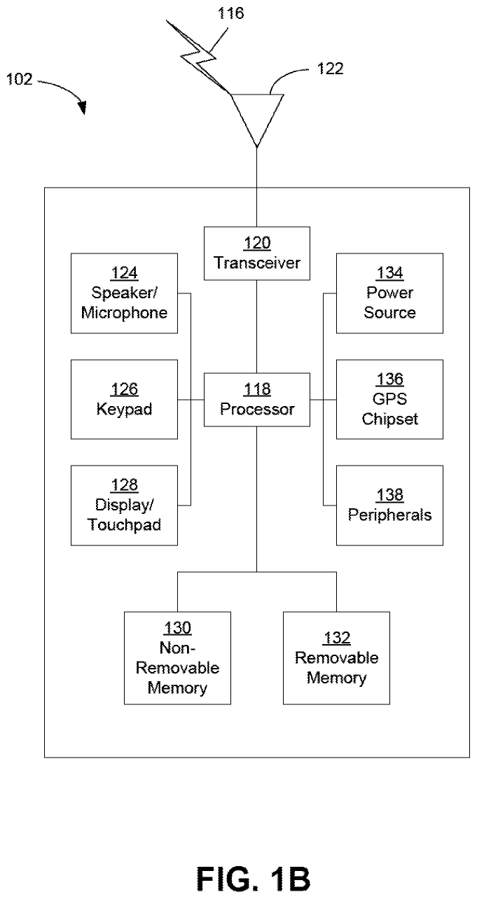

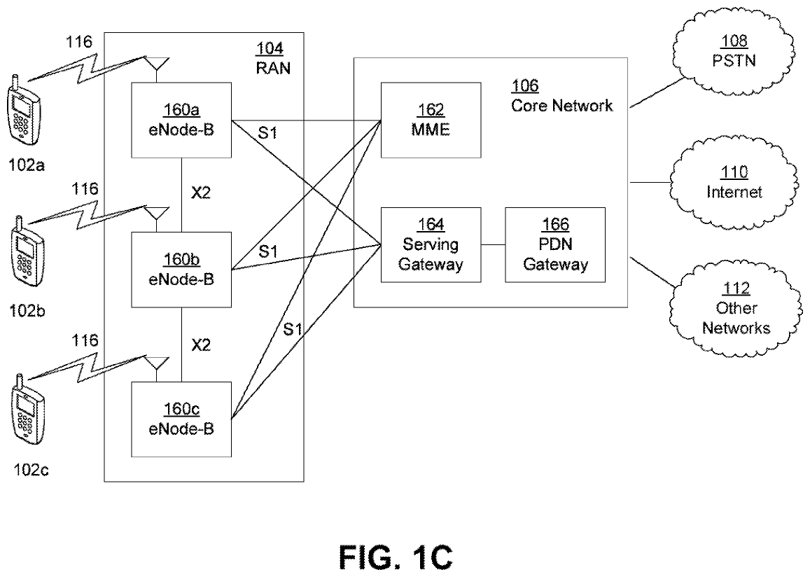

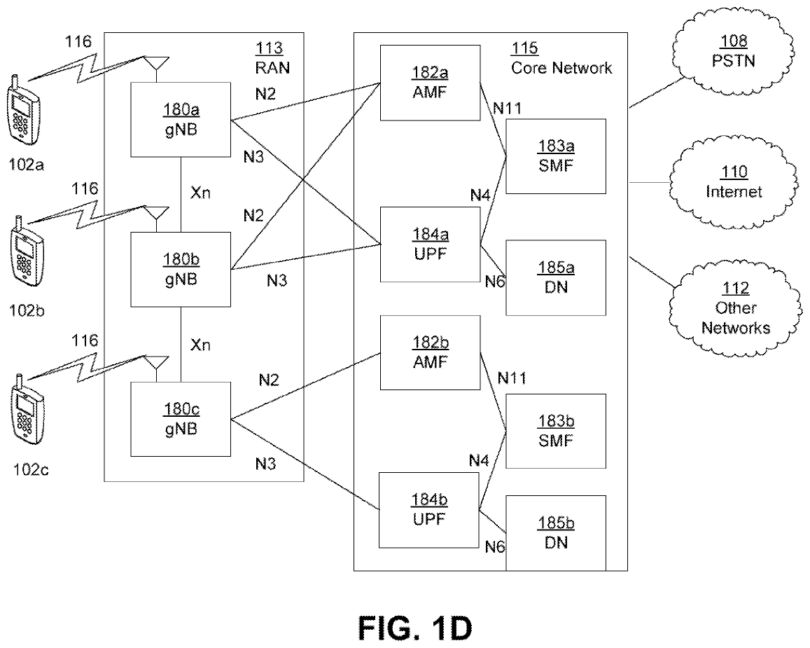

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHZ channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

One or more features associated with a WTRU that is being served via a first cell (e.g., of a non-terrestrial network (NTN) satellite) for handling the uplink and/or downlink (UL and/or DL) data transmission and/or reception associated with (e.g., during) handover from the first cell to a second cell of (e.g., of another NTN satellite) may be provided. One or more of the following may be performed by the WTRU. The WTRU may receive triggering configuration information (e.g., information that indicates triggering conditions), where the triggering configuration information may indicate condition(s) associated with starting and/or stopping a dual connection (e.g., a carrier aggregation (CA) operation) with the first cell and the second cell, for example the carrier aggregation may be started or stopped based on whether one or more of the conditions are satisfied. The triggering configuration information may be the same or different for the UL and DL. The triggering configuration information may include one or more of the following (e.g., on which starting or stopping a CA operation may be based): a command (e.g., explicit command) to start or stop the dual connection; time information (e.g., a time condition); location information (e.g. a location condition); timing advance information (e.g., a timing advance condition) and/or pre-compensation information (e.g., a time/frequency pre-compensation condition); cell information (e.g., list of candidate cell information in physical cell identity (PCI), cell global identity (CGI), frequency, etc.); or signal level threshold(s). The WTRU may receive configuration information regarding the WTRU UL behavior to use in association with activation of the target (e.g., second) cell (e.g., for carrier aggregation operation). For example, the configuration information may configure the WTRU to facilitate faster activation of the target cell. The configuration information may indicate that the WTRU use faster CQI reporting associated with the target cell, where in examples the CQI reporting associated with the target cell (e.g., second cell) may be faster than CQI reporting associated with the source cell (e.g., first cell). The faster CQI reporting may be performed prior to the WTRU starting the connection towards the second cell. The configuration information may include triggering condition(s) for the WTRU to start the UL signaling (e.g., the faster CQI reporting). The WTRU may monitor the triggering condition(s) for starting the UL signaling towards and/or regarding the second cell for activation (e.g., for faster activation as described herein). The WTRU may monitor the triggering condition(s) for starting the connection towards the second cell (e.g., for starting CA operation). In examples, if the triggering condition(s) for starting the UL signaling towards and/or regarding the second cell for activation (e.g., faster activation as described herein) are (e.g., determined to be) satisfied (e.g., met), one or more of the following may be performed by the WTRU: start the UL signaling (e.g., faster or more frequent CQI reporting as described herein) for activation (e.g., faster activation) of the second cell; or, update WTRU location (e.g., for facilitating TA pre-compensation calculation towards the second cell). In examples, if the conditions for establishing the connection to the second cell are (e.g., determined to be) satisfied (e.g., met), one or more of the following may be performed by the WTRU: start monitoring the physical downlink control channel (PDCCH) of the first and/or second cell for DL data and/or UL grants regarding the second cell (e.g., maintain a connection to the first cell while initiating a connection with the second cell); send and/or receive (e.g., data) based on UL and/or DL network scheduled resources to/from the first and second cells; or, start monitoring terminating triggering conditions for stopping the connection to the first cell (e.g., for the WTRU to disconnect from the first cell, for example stopping the CA operation). In examples, the sending and receiving may include the following (e.g., as described herein): a reception of a PDCCH transmission via the first cell (e.g., a first action), where the PDCCH transmission may indicate a resource associated with the second cell and the resource is for a DL transmission from the second cell or for an UL transmission to the second cell; and a communication with the second cell via the resource (e.g., second action). If the terminating triggering conditions for releasing (e.g., disconnecting from) the first cell are (e.g., determined to be) satisfied (e.g., met), one or more of the following may be performed by the WTRU: terminate the connection with (e.g., disconnect from) the first cell (e.g., stop monitoring the PDCCH of the first cell, stop sending UL data and/or scheduling request(s) (SR(s) towards the first cell, etc.); or operate the connection with the second cell (e.g., only with the second cell, for example stopping the CA operation).

(NTNs may be used in association with one or more features described herein. NTNs may facilitate deployment of wireless networks in area(s) where land-based antennas are impractical, for example, due to geography or cost. NTN may increase network coverage.

An NTN may comprise an aerial and/or space-borne platform which, via a gateway (GW), transports signals from a land-based gNB to a WTRU and vice-versa. A power class 3 WTRU with an omnidirectional antenna and linear polarization and/or a very small aperture antenna terminal (VSAT) with a directive antenna and circular polarization may be supported. Narrow-band IoT (NB-IoT) and eMTC type devices may be supported. NTN WTRUs may be a global navigation satellite system (e.g., GNSS_capable).

Aerial and/or space-borne platforms may be classified in terms of orbit (e.g., low-earth orbit (LEO) satellites with an altitude range of 300 to 1500 kilometers (km) and/or geostationary earth orbit (GEO) satellites with altitude at 35 786 km. In examples, platform classifications such as medium-earth orbit (MEO) satellites with an altitude range of 7000 to 25000 km and high-altitude platform stations (HAPS) with altitude of 8 to 50 km may be supported (e.g., implicitly supported). Satellite platforms may be classified as having a transparent and/or regenerative payload. Transparent satellite payloads may implement frequency conversion and/or RF amplification in both uplink and downlink with multiple transparent satellites connected to a land-based gNB. Regenerative satellite payloads may implement either a full gNB or gNB DU onboard the satellite. Regenerative payloads may perform digital processing on the signal, for example, including demodulation, decoding, re-encoding, re-modulation and/or filtering.

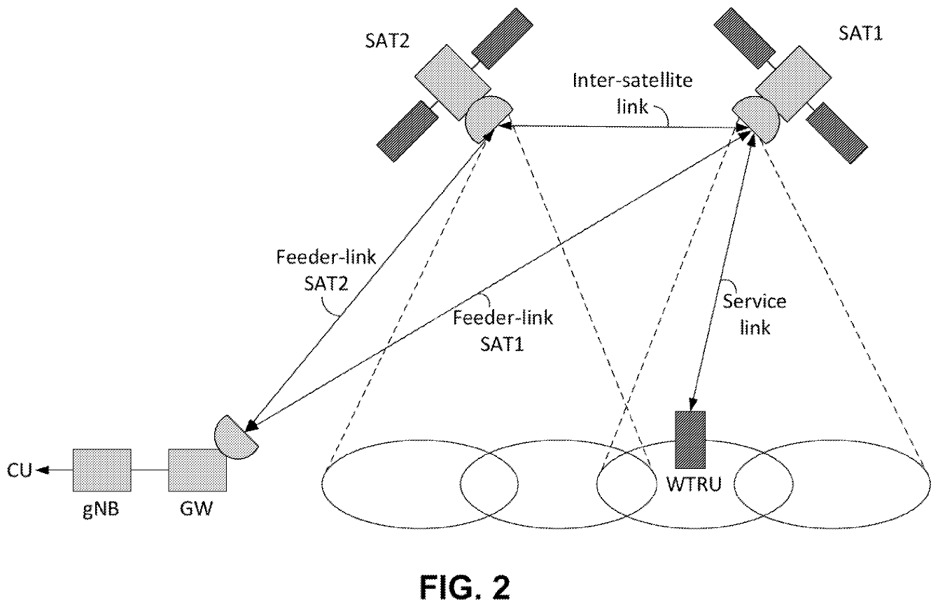

FIG. 2 shows an example of different interfaces in a non-terrestrial network. One or more of the following radio interfaces may be defined in NTN: feeder-link, which may be a wireless link between the GW and satellite; service link, which may be a radio link between the satellite and WTRU; or inter-satellite Link (ISL), which may be a transport link between satellites. The ISL may be supported by regenerative payloads (e.g., only by regenerative payloads) and may be a radio and/or optical interface.

Depending on the satellite payload configuration, different interfaces may be used for one or more radio links (e.g., each radio link). For a transparent payload, the radio interface, such as an NR Uu interface, may be used for both the service link and feeder-link. For a regenerative payload, the interface, such as an NR Uu interface, may be used on the service link and a satellite radio interface (SRI) may be used for the feeder-link. A detailed user plane and/or control plane (UP and/or CP) protocol stack for a payload configuration (e.g., each payload configuration) may be used.

An NTN satellite may support multiple cells, where a cell (e.g., each cell) may comprise one or more satellite beam(s). Satellite beam(s) may cover a footprint on earth (e.g., a terrestrial cell) and may range in diameter from 100 to 1000 km in LEO deployments and 200 to 3500 km diameter in GEO deployments. Beam footprints in GEO deployments may remain fixed relative to earth and in LEO deployments the area covered by a beam and/or cell may change over time due to satellite movement. The beam movement may be classified as earth moving where the LEO beam moves (e.g., moves continuously) across the earth or may be classified as the earth fixed where the beam is steered to remain covering a fixed location until a cell (e.g., new cell) overtakes the coverage area in a discrete and/or coordinated change.

Based on the altitude of NTN platforms and/or the beam diameter, the round-trip time (RTT) and/or maximum differential delay may be larger than that of terrestrial systems. In a transparent NTN deployment, RTT may range from 25.77 ms (e.g., LEO at 600 km altitude) to 541.46 ms (e.g., GEO) and the maximum differential delay may range from 3.12 ms to 10.3 ms. The RTT of a regenerative payload may be half that of a transparent payload, as a transparent configuration may comprise both the service and feeder links whereas the RTT of a regenerative payload may be limited to considering the service link. In examples, to minimize impact to existing NR systems (e.g., to avoid preamble ambiguity and/or properly time reception windows), prior to initial access, a WTRU may perform timing pre-compensation.

Enhancements involving WTRU mobility and/or measurement reporting may be used. The difference in reference signal received power (RSRP) between cell center and/or cell edge may not be as pronounced as in terrestrial systems. This, e.g., coupled with the larger region of cell overlap, may result in traditional measurement-based mobility becoming less reliable in an NTN environment. Conditional handover and/or measurement reporting triggers may rely on location and/or time. Enhanced mobility may be of interest in LEO deployments where, due to satellite movement, a stationary WTRU may be expected to perform mobility approximately every 7 seconds (e.g., depending on deployment characteristics).

Timing advance (TA) pre-compensation in NTN may be provided. Timing pre-compensation in NTN may involve the WTRU obtaining its position via GNSS, the feeder-link delay (e.g., or common delay), and/or satellite position via satellite ephemeris data. The satellite ephemeris data may be broadcasted (e.g., periodically broadcasted) via system information and/or may include the satellite speed, direction, and/or velocity. The WTRU may estimate the distance (e.g., and delay) from the satellite and/or may add a delay component (e.g., common delay component) to obtain the full WTRU-gNB RTT, which may be used to offset timers, reception windows, and/or timing relations. In examples, frequency compensation may be performed by the network. The estimate of the WTRU's TA may be given by the sum of the WTRU's TA and K_mac, where the WTRU's TA is provided by the following:

$${T}_{T A} = ( {N}_{T A} + {N}_{TA , UE - specific} + {N}_{TA , common} + {N}_{TA , offset} ) \times {T}_{c}$$

### Where:

N_{TA} is defined as 0 for PRACH and updated based on TA Command field in msg2/msgB and MAC CE TA command.
N_{TA,UE-specific} is WTRU self-estimated TA to pre-compensate for the service link delay.
N_{TA,common} is network-controlled common TA, and may include a timing offset (e.g., any timing offset) considered necessary by the network.
N_{TA,common} with value of 0 is supported.
N_{TA,offset} is a fixed offset used to calculate the timing advance.

In examples, if the reference point for timing calculation is not located at the gNB, K_mac may be used to compensate the additional delay between the reference point and gNB to obtain the full satellite-gNB delay. If no K_mac value is provided in system information (SI), it may be assumed K_mac is zero.

In examples, if configured by a network (e.g., based on being explicitly enabled in an SI, the WTRU may report an estimate (e.g., coarse estimate) of the WTRU TA pre-compensation value to the network, for example in Msg5 via a MAC CE e.g., in order for the network to update K_offset. In connected mode, the WTRU may report an estimate of the timing pre-compensation, for example, periodically based on a request from the network and/or based on being triggered by an event (e.g., the TA pre-compensation value has changed by a delta greater than a threshold). In examples, the network may configure the WTRU to report it's location information such that the network may calculate the TA value.

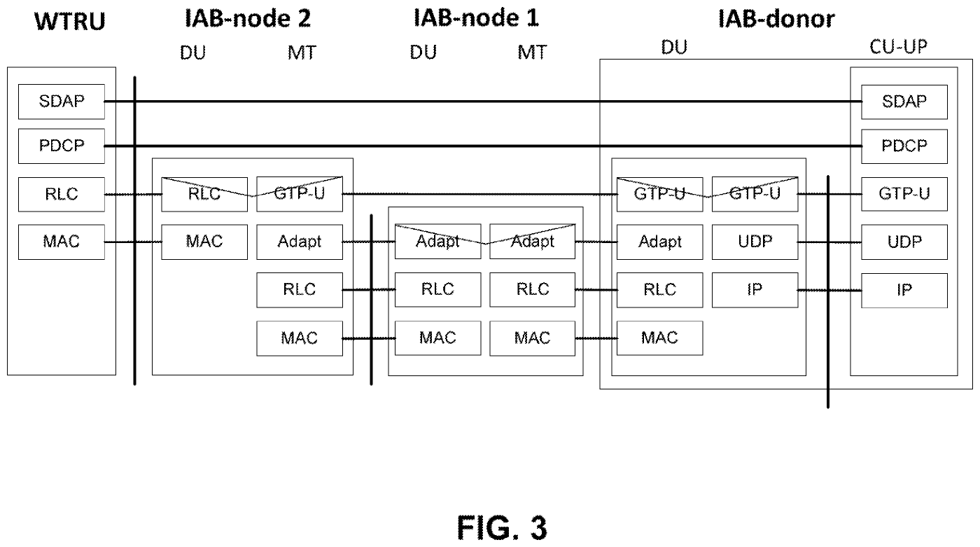

FIG. 3 shows an example Integrated Access and Backhaul (IAB) User Plane. IAB, where part of the wireless spectrum is used for the backhaul connection of base stations instead of fiber, may allow a flexible and/or cheaper deployment of networks (e.g., dense networks) as compared to deployments where there is a dedicated fiber link to the base stations. A multi-hop IAB that is based on split architecture may be used. The UP and CP exemplary architecture may be used.

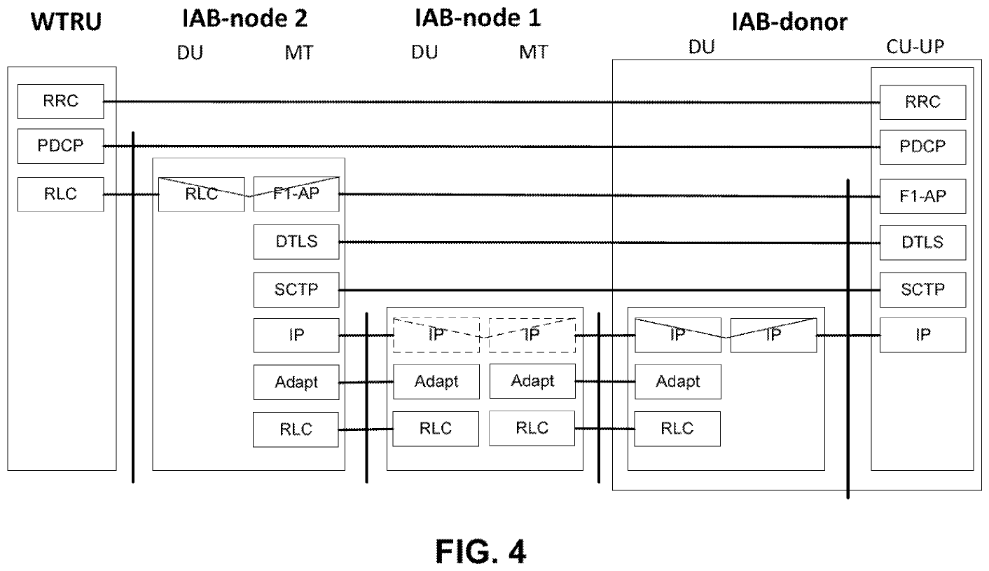

FIG. 4 shows an example IAB Control Plane. In examples, the IAB node's protocol stack may comprise two sides. The stack may comprise the mobile termination (MT) part which may be used to communicate with a parent node and a distributed unit (DU) part which may be used to communicate with a child node and/or a normal WTRU. Both the UP and CP architectures may employ a routing and/or forwarding technique based on IP networks, where an IAB node (e.g., each IAB node) is assigned an IP address that is routable from a donor base station (e.g., and associated L2 addresses) and intermediate IAB nodes forward the packets (e.g., transparently) based on route identifiers and/or destination addresses. The IAB node may terminate the DU functionality and a base station (e.g., referred to as IAB-donor) may terminate the centrialized unit (CU) functionality. The IAB node and donor CU, e.g., regardless of how many hops apart they are physically from each other, may form a logical base station unit employing CU and DU split architecture. The IAB node serving a WTRU may be referred to as the access IAB node and the nodes between the IAB donor DU and the access IAB node may be known as intermediate IAB nodes. An IAB node may play the role of both an access IAB node (e.g., for the WTRUs that are directly connected to it) and an intermediate IAB node (for WTRUs that are served by its descendant IAB nodes).

Hop-by-hop radio link control (RLC) may be used between the IAB nodes, e.g., instead of an End to End (E2E) RLC between the donor DU and the WTRU. An adaption layer, referred to as backhaul adaptation protocol (BAP), may be used to enable multi-hop forwarding (e.g., efficient multi-hop forwarding). The IAB-donor may assign a unique L2 address (e.g., BAP address) to one or more IAB node(s) (e.g., each of the one or more IAB nodes) that it controls. For multiple paths, multiple route IDs may be associated with one or more BAP address(es) (e.g., each of the one or more BAP addresses). The BAP of the origin node (e.g., IAB-donor DU for the DL traffic and the access IAB node for the UL) may add a BAP header to packets that they are transmitting, for example, which may include a BAP routing ID (e.g.m BAP address of the destination and/or source IAB node and the path ID). In examples, if a packet arrives that has a BAP routing ID that comprises a BAP address that is equal to the IAB nodes BAP address, the IAB node may know that the packet is destined for it and may pass it on to higher layers signaling for processing (e.g., an F1-C/U message destined for the IAB node's DU, an F1-C message that comprises SRB data for a WTRU directly connected to the IAB node, or an F1-U message that comprises data radio bearer (DRB) data for a WTRU directly connected to the IAB node). In examples, the IAB node may employ routing and/or mapping tables to determine where to forward the data. An IAB node (e.g., each IAB node) may have a routing table (e.g., configured by the IAB donor CU) comprising the next hop identifier for a BAP routing ID (e.g., each BAP routing ID). Separate routing tables may be kept for the DL and UL direction, where the DL table may be used by the DU part of the IAB node and the MT part of the IAB node may use the UL table.

Backhaul (BH) RLC channels may be used for transporting packets between IAB nodes (e.g., or between an IAB-donor DU and an IAB node). A BH RLC channel configuration may comprise the associated RLC and logical channel configuration. Many-to-one (e.g., N:1) or one-to-one (e.g., 1:1) mapping may be performed between WTRU radio bearers and BH RLC channels. N:1 mapping may multiplex multiple WTRU radio bearers into a BH RLC channel (e.g., single BH RLC channel) based on parameters (e.g., specific parameters such as QoS profile of the bearers) and may be suitable for bearers that do not have strict requirements such as best effort bearers. The 1:1 mapping may map one or more WTRU radio bearer(s) (e.g., each of the one or more radio bearers) onto a separate BH RLC channel and may be designed to ensure finer QoS granularity at WTRU radio bearer level. 1:1 mapping may be suitable for bearers with strict throughput and/or latency requirements, such as GBR (Guaranteed Bit Rate) bearers and/or VoIP bearers.

In examples, if an IAB node detects a BH radio link failure (RLF), the IAB node may send a BH RLF indication, e.g., which is a BAP control PDU, to its descendant nodes. Based on receiving the indication form a parent node, the IAB node may initiate techniques such as re-establishment to another parent or pausing transmission and/or reception with the concerned parent.

In a multi-hop IAB network, data congestion may occur on an intermediate IAB node, for example, which may lead to packet drops if left unresolved. Though higher layer protocols such as TCP may be used to assure reliability, TCP congestion avoidance and/or slow start features may be costly to overall end-to-end performance (e.g., throughput degradation). IAB networks may employ flow control. For the DL, both end to end (E2E) and hop by hop (H2H) flow control features may be supported.

The DL E2E flow control may be based on the DL Data Delivery Status (DDDS) specified for CU and/or DU split architecture. In DDDS, the DU (e.g., in the context of IAB networks, the DU part of the access IAB node) may report to the CU (e.g., in the context of IAB networks, the donor CU, such as the CU-UP) information such as the desired buffer size per DRB, desired data rate per DRB, the highest successfully delivered packet data convergence protocol (PDCP) SN, lost packets (e.g., not ACKed by the DU at RLC level), etc. Access IAB nodes (e.g., only access IAB nodes) may perform DDDS (e.g., IABs report only information concerning the DRBs of the WTRUs that they are directly serving) and no information may be provided regarding the BH RLC channels.

For DL H2H flow control, an IAB node may generate a flow control message (e.g., which may be additionally a BAP control PDU) if its buffer load exceeds a level and/or if it receives a flow control polling message from a peer BAP entity (e.g., a child node). In examples, the H2H flow control information may indicate the available buffer size, which may be at the granularity of BH RLC channels (e.g., available buffer equals value_1 for BH RLC channel #1, available buffer equals value_2 for per BH RLC channel #2, etc.) and/or destination routing ID (e.g., available buffer equals value_1 for destination routing ID1,available buffer equals value_2 for destination routing ID2, etc.). The node receiving the flow control message may use the information to control the traffic flow towards the sender (e.g., throttle and/or pause the traffic associated with a BH RLC channel and/or destination if the flow control message indicated a low available buffer for the concerned traffic, increase the traffic flow if the flow control indicated a high available buffer value, etc.).

In examples, pre-emptive buffer status reporting (BSR) may be specified, where an IAB node may trigger BSR to its parent node(s) before data (e.g., new data) has arrived in its UL buffer based on the BSR that it has received from its child nodes or WTRUs and/or based on scheduling grants it has provided to them (e.g., an indication of anticipated data). In examples, an IAB node may control the flow of UL data from its children nodes and the WTRUs by providing them with proper UL scheduling grants based on the BSR received from them. IAB nodes may be static nodes. Handover of IAB nodes (e.g., referred to as migration and/or relocation) from one donor to another may be supported for load balancing and/or for handling RLFs based on blockage (e.g., due to moving objects such as vehicles, seasonal changes such as foliage, and/or infrastructure changes such as new buildings). In examples, intra-donor CU handover (e.g., only intra-donor CU handover) may be supported (e.g., the target and the source parent DUs of the IAB node are controlled by the same donor CU) and inter-donor CU handover may be specified.

IAB connectivity via MR-DC may be supported. In examples, an IAB node may be connected to the network via EN-DC, where the master node is an LTE node and the secondary node is an NR node.

In examples, transparency may be provided. For example, from a WTRU's point of view, IAB nodes may appear to be normal base stations.

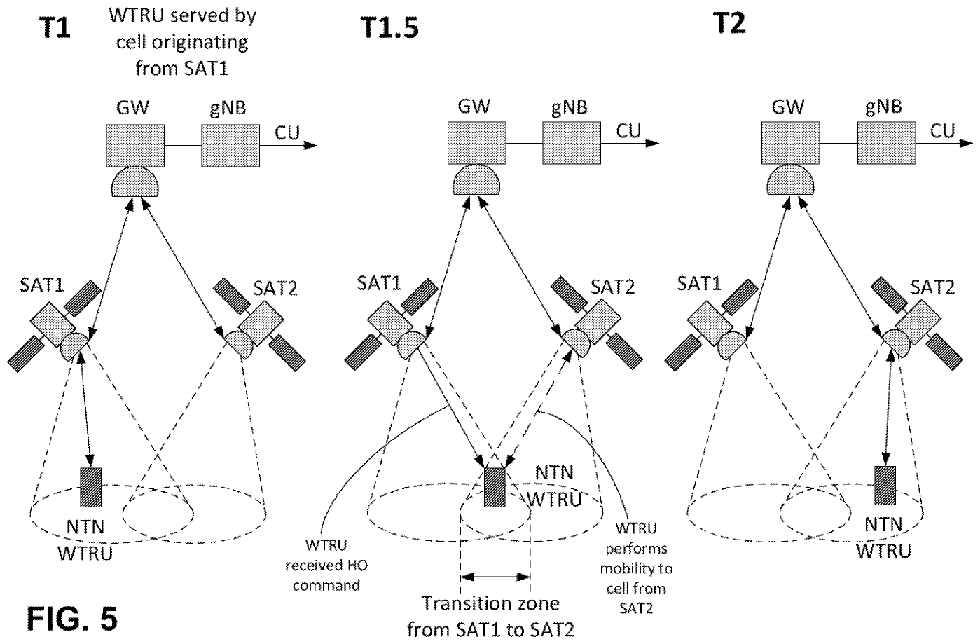

FIG. 5 shows example inter-satellite mobility associated with a WTRU (e.g., an NTN WTRU). In an exemplary NTN, different satellites (e.g., two different satellites) may serve the same gNB, and each may have a unique set of cells. A WTRU performing inter-satellite mobility may follow a handover (HO) procedure comprising neighbor cell measurement, measurement report, reception of HO command, and/or random access to the satellite (e.g., new satellite). Pre-compensation may be used (e.g., required) on the WTRU side, for example, if the timing difference between satellites has not been corrected by the previously served gNB (e.g., via a timing advance MAC CE). Based on the larger propagation delay, latency associated with the mobility procedure may result in long service interruption in the event of HO failure, for example, due to radio link issues and/or incorrect pre-compensation to the satellite (e.g., new satellite). This may be present in LEO deployments, where the fast movement of satellites results in a handover approximately every seven seconds for stationary WTRUs. Increased robustness of the HO feature for singular WTRUs, for example, via additional time-based and location-based conditional handover triggers may be supported. In examples, NTN support may be extended to IAB nodes. Candidate uses may be, for example, having one or more IAB node(s) servicing WTRUs within an airplane or cruise ship, a land-based IAB node with NTN backhaul, and/or a HAPS-based device providing service in an emergency setting. This deployment scenario may result in the ability for a smartphone (e.g., one without external antennas) to access NTN systems via the IAB node antenna and WTRU power-saving may be provided (e.g., as the WTRU-IAB radio-link characteristics would be much more favorable than a WTRU-satellite radio link). In an exemplary IAB scenario, the backhaul link to the donor DU may be transported by the satellite via an interface (e.g., such as an Uu interface). In inter-satellite handover, the IAB DU may transfer the backhaul link from SAT1 to SAT2. This may be done in a seamless fashion (e.g., or else WTRUs such as downstream IAB nodes may experience extended service interruption). Multiple WTRUs may be (e.g., need to be) simultaneously transitioned over to the satellite (e.g., new satellite), for example, in a LEO earth-fixed beam deployment. For example, multiple WTRUs may attempt to access the cell (e.g., new cell) simultaneously, leading to a possible random access channel (RACH) collision and/or an HO failure. In examples, it may be desirable to ensure that IAB nodes serving multiple WTRUs and/or downstream IAB nodes receive priority if performing mobility.

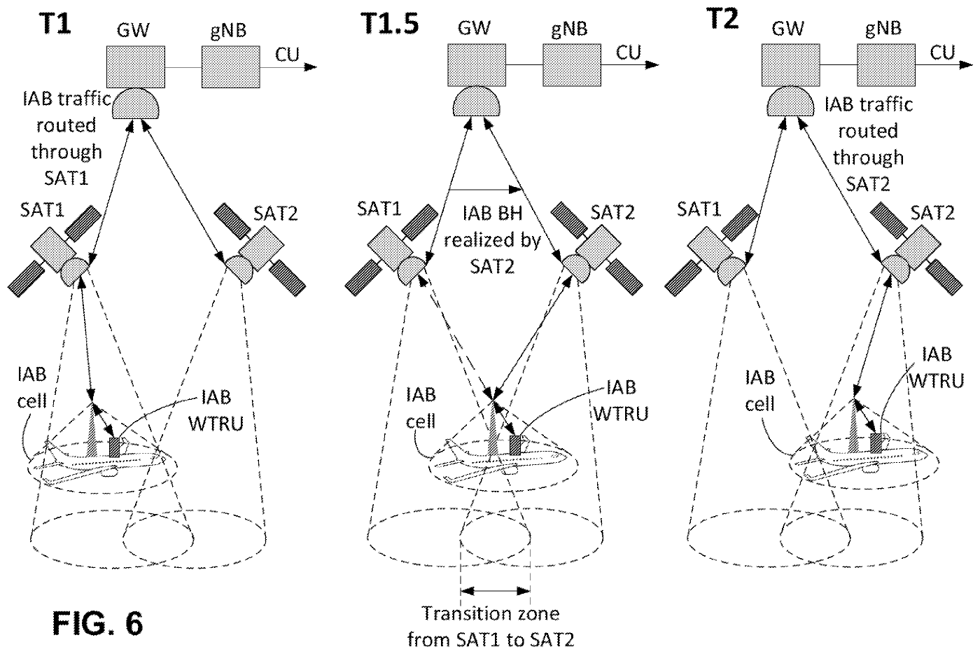

FIG. 6 shows example inter-satellite mobility associated with an IAB node. In examples, a WTRU may not be aware that it is connected to an IAB node verses a regular gNB and a WTRU may be unaware that it is being served as part of an NTN system. For inter-satellite HO, backhaul conditions may change, for example, in terms of link quality and/or time-frequency compensation requirements. In examples, the WTRU may not detect a change in the cell and there may be an impact to the ability to service QoS requirements of different radio bearers.

IAB scenarios may be described herein. The scanerios may be applicable as described. The scenarios may be applicable to a WTRU directly connected to an NTN satellite. The scenarios may be applicable to non-NTN situations (e.g., a mobile cell, network deployments with high RTT, etc.)

A WTRU may refer to a wireless device (e.g., any wireless device) that is communicating with a wireless/mobile network infrastructure (e.g., a smart phone, a computer, laptop, and/or tablet with wireless connectivity, a sidelink relay that is used to relay data between another device and a network, a sidelink device that is used to relay data between two other devices, the MT of an IAB node that is relaying data for a multitude of WTRUs and/or other IAB nodes, etc.)

The configurations used (e.g., required) for enabling the features regarding the behavior may be provided to the WTRU, e.g., via an interface (e.g., such as a Uu interface) between the WTRU and the gNB (e.g., RRC signaling, SIB signaling, MAC CEs, DCIs, etc.). If the WTRU is referring to the MT of an IAB node, the IAB node may be configured via the F1 interface between the donor gNB and the IAB DU. Configuration may be provided via Operation, Administration, and Management (OAM) interface and/or signaling

For the transparent NTN architecture, the satellites may be transparently forwarding the data between the IAB node and the donor gNB that is controlling the IAB node.

The features described herein may focus on the handover and transition between cells (e.g., two cells) controlled by different satellites. In examples, the features may be applicable to the case where the cells are controlled by the same satellite.

The terms first cell and serving cell may be used interchangeably herein. The terms second cell and target cell may be used interchangeably herein.

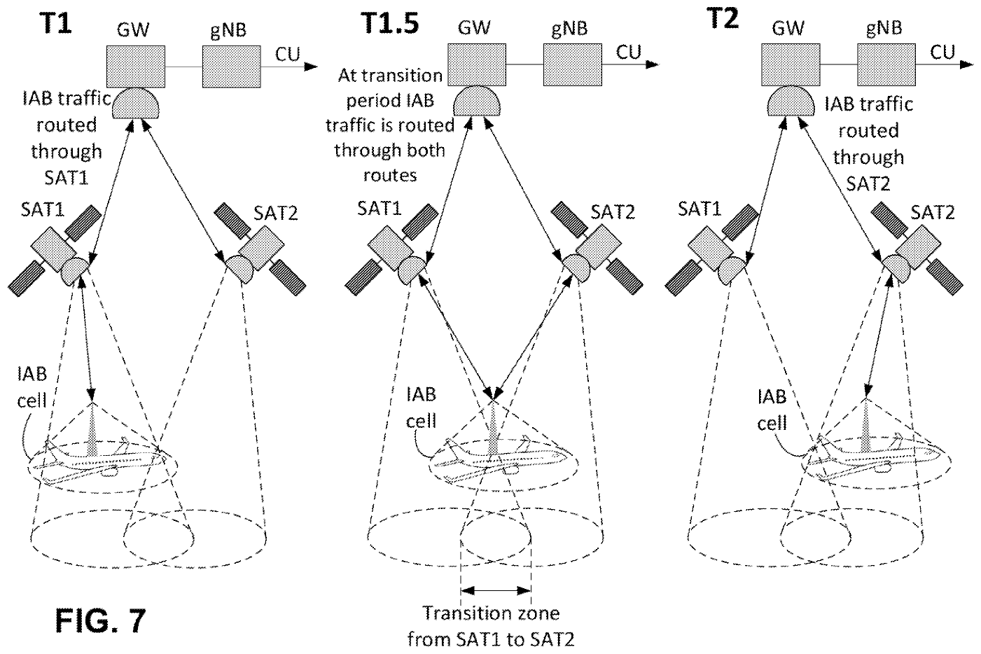

FIG. 7 shows an example multiple connection to both satellite cells, e.g., to minimize service interruption time. Features for conditional carrier aggregation (CA), e.g., for reducing and/or preventing service interruption, may be provided. During a transition period from one cell (e.g., source cell) to another one (e.g., target cell), where the cells are controlled by the same or different NTN satellites, UL/DL traffic may be temporarily routed to both cells before UL/DL connectivity is switched (e.g., completely switched) to the target cell and/or satellite. In examples, triggering conditions for initiating the CA operation between the cells (e.g., two cells) may be supported. Triggering conditions for stopping the CA operation and switching the connection to the target cell may be supported. WTRU behavior associated with the CA operation may be described herein.

Conditional triggering of the establishment and termination of CA (e.g., CA-like operation, for example as described herein) between satellite cells (e.g., first cell and second cell) may be provided. The CA establishment or termination may be triggered based on a condition or combination of conditions such as those described herein.

Triggering of connection to the target cell (e.g., second cell) may be based on time information (e.g., a time condition). The WTRU may be provided with a configuration (e.g., information) that includes trigger conditions for initiating a connection towards a target cell (e.g., second cell), e.g., while maintaining the connection with the source cell (e.g., first cell), e.g., based on time-related information/condition(s). The source cell and target cell may be controlled by the same or different satellites.

The WTRU may be configured with an absolute time (e.g., 10:30:25 AM) to start the connection to the target cell. The WTRU may be configured with a relative time configuration to start the connection with the target cell. The WTRU may be configured with a range of absolute times or relative times (e.g., between 10:30:25 AM and 10:35:10 AM, between 10 s and 20 s after the reception of the configuration message, etc.). The WTRU may be configured with an absolute time indicating an initiation time and a duration in which the main configuration remains valid (e.g., 10:30:25 am±90 s).

Triggering of a connection to the target cell may be based on a timing advance and/or angle of arrival. The WTRU may be provided configuration information that includes trigger conditions for initiating a connection towards a target cell, e.g., while maintaining the connection with the source cell, for example based on a TA and/or angle of arrival (AoA)-related information.

The WTRU may initiate a connection to the target cell, for example, if the estimated TA pre-compensation value (e.g., WTRU-gNB RTT) via the target cell is at or less than a threshold. The WTRU may initiate a connection to the target cell, for example, if the TA with the current cell is greater than a threshold. The WTRU may initiate a connection to the target cell if the TA with the current cell is greater than a threshold and the estimated TA with the target cell is less than a threshold. The WTRU may initiate a connection to the target cell based on the comparison of the TA (e.g., or estimated TA) values towards the source cell and target cell (e.g., if the estimated TA towards the target is not more than a configured threshold above the TA to the source, if the estimated TA towards the target becomes lower than the TA to the source, etc.). The WTRU may initiate a connection to the target cell based on the rate of change of the TA (e.g., estimated TA) towards the source cell and/or target cell. The WTRU may initiate a connection to the target cell, for example, if the AoA of the signal from the source cell is greater than a threshold, less than a threshold, or falls within a given range of values. The WTRU may initiate a connection to the target cell if the AoA of the signal from the target cell is greater than a threshold, less than a threshold, or falls within a given range of values. The WTRU may initiate a connection based on the comparison of the AoA from the source and target cell (e.g., if the AoA from the target becomes bigger than that from the source or vice versa, if the AoA from the target becomes a number of degrees smaller or larger than the AoA from the target, if the AoA from the target becomes bigger than a certain value and the AoA from the source becomes smaller than the value or vice versa, etc.).

Triggering of a connection to the target (e.g., target cell) may be based on location (e.g., a location condition) and/or distance information. The WTRU may be provided with a configuration that includes trigger conditions for initiating a connection towards a target cell, e.g., while maintaining the connection with the source cell, based on location and/or distance-related information.

The WTRU may be configured with an absolute location (e.g., GNSS coordinates) and if the WTRU detects that its current location is the specified location, the WTRU may start the connection with the target cell. The absolute location may not be the location of the WTRU, but rather the location of the satellite (e.g., as indicated in the SIB signaling of the satellite cell), for example if the satellite location is determined to be the configured absolute location the WTRU may start the connection with the target cell.

The WTRU may be configured with a relative location (e.g., a specified m or km from the reception of the configuration message), e.g., instead of absolute location. The WTRU may try establishing a connection with the target cell if it has detected that it has moved by a specified distance. In examples, additional information may be specified and/or used by the WTRU in determining the establishment of the connection (e.g., direction of travel in degrees or specific direction information like southwest, etc.).

The WTRU may (e.g., instead of absolute location or relative location information) be configured with distance information between the WTRU and the source and/or target satellite, which the WTRU may use to trigger the additional connection. In examples, the WTRU may be configured to trigger the connection to the target cell based on determining that the distance from the source satellite and/or the target satellite is equal, greater, less, or within a value or value range.

In examples, the WTRU may be configured with a range of absolute or relative locations and/or distances (e.g., two GNSS coordinates, two distance values from the current location, etc.) based on or during which the connection to the target is to be established.

The WTRU may be configured with a distance threshold between itself and a reference point (e.g., cell and/or beam center), which may be used to trigger the connection to the target. For example, the WTRU may receive (e.g., via system information) reference coordinates associated with the serving and/or neighboring cell. The WTRU may trigger the connection to the neighbor cell, for example, if one or more of the following conditions are satisfied: distance between the WTRU and serving cell reference point is above a threshold (e.g., greater than a threshold); distance between the WTRU and the neighboring cell is below a threshold (e.g., less than a threshold); or difference between serving cell reference point and target cell is above and/or below a threshold.

Information indicating the target cell to connect with may be provided. The candidate target cell with which to form an additional connection if the configured time, location, TA, and/or AoA-based trigger conditions are satisfied may be explicitly specified (e.g., PCI, CGI, frequency info, etc.). A set of specific cells to form an additional connection with may be specified. The WTRU may choose a cell (e.g., the best cell) among the specified ones, for example, if the trigger conditions are satisfied.

A signal level threshold (e.g., reference signal received power (RSRP), reference signal received quality (RSRQ), and/or signal to interference noise ratio (SINR) threshold) may be used and/or specified. In examples, e.g., if no cell identification is specified, the WTRU may choose to form an additional connection with one of the neighbor cells (e.g., randomly chosen) that has a signal level that satisfies (e.g., is above) the signal level threshold and/or to form an additional connection with the best cell among the neighbor cells that satisfy the specified threshold. As described herein, a triggering condition for starting the faster activation of the target cell (e.g., second cell) may include the signal level threshold.

If a cell identification (e.g., or set of identifications) are specified along with signal level thresholds, the WTRU may consider and/or monitor those cells (e.g., only those cells). The WTRU may choose to form an additional connection with one of the specified neighbor cells (e.g., randomly chosen) that has a signal that satisfies (e.g., is above) the specified threshold and/or to form an additional connection with the best cell among the specified neighbor cells that satisfy the specified threshold.

The WTRU may be provided with multiple configurations that are applicable for different time and/or location instances. The WTRU may be provided with a timetable (e.g., or location table) along with an identification of a set of candidate cells as well as signal level thresholds. The signal level thresholds may be common for the whole configuration. The signal level thresholds may be specific to one or more time and/or location entry (e.g., each of the one or more time/location entry) in the time and/or location table.

Triggering of the tearing down of the multiple connection (e.g., which may include the WTRU disconnecting from the first cell as described herein) may be provided. The WTRU may keep the connection towards the cells (e.g., two cells), for example, until an explicit configuration and/or indication (e.g., indication to stop the CA operation) is received from the network, which may be received via the source cell or the target cell. The explicit configuration and/or indication may be a control plane message (e.g., RRC reconfiguration, MAC CE, DCI, etc.). The explicit configuration and/or indication may be a user plane message (e.g., an RLC and/or PDCP packet with a certain flag/indicator). Time duration information may be provided regarding how long the connection with the cells (e.g., two cells) should be kept.

Location and/or distance information may be provided regarding how long the connection with the cells (e.g., two cells) should be kept (e.g., for x meters after the connection to the target is started, y seconds after the connection to the target is started, etc.).

TA and/or AoA information may be provided regarding how long the connection with the cells (e.g., two cells) should be kept (e.g., if the TA to the source cell has increased by a configured amount after the connection to the target is started, if the TA to the target has decreased by a configured amount after the connection to the target is started, etc.).

The WTRU may experience good radio link quality (e.g., signal strength above a threshold) from the cell (e.g., first cell or second cell) that it is about to terminate the connection with (e.g., based on the fulfillment of the triggering conditions for terminating the dual connection to both cells), while experiencing radio link issues such as poor signal strength and congestion with the cell in which connection is to be maintained. The WTRU may delay the triggering of the release of the connection with the concerned cell. For example, the WTRU may delay the termination of the connection (e.g., until the cell's signal quality falls below a threshold and/or until the other cell's signal quality becomes stronger than a threshold, etc.).

Separate configuration of the UL versus DL connectivity and/or operation may be provided. The triggers for starting the double connection (e.g., explicit indication, time, location, TA, and/or AoA-based triggers) may be the same for both starting the double connection in UL and DL. The triggers for starting the double connection may be different for UL and DL. The triggers for terminating the double connection may be the same for both UL and DL. The triggers for terminating the double connection may be different for UL and DL. In examples, if the triggers to start a double connection are different for UL and DL and conditions have been satisfied for one direction (e.g., only one direction such as UL), the WTRU may start the double connection for the other direction (e.g., DL) after an offset (e.g., K_offset). In examples, if the trigger to terminate a double connection are different for UL and DL and conditions have been satisfied for terminating the double connection for one direction (e.g., only one direction such as UL), the WTRU may terminate the double connection for the other direction (e.g., DL) after an offset (e.g., K_offset).

WTRU behavior may be provided. If it is time to start the double connection (e.g., CA operation) towards the two (e.g., the first cell and the second cell) cells (e.g., explicit indication received, trigger condition(s) as described herein are satisfied, such as time, location, TA and/or AoA-based triggers being fulfilled), the WTRU may start sending fast (e.g., more frequent) CQI reports of the target cell (e.g., send CQI reports associated with the second cell more frequently and/or using a shorter periodicity as compared to how frequently CQI reports of the first cell (e.g., connection already established) are sent, where the CQI reports associated with the first cell may be sent using a longer periodicity), for example, to facilitate the activation of the target cell. The duration for the sending of these fast CQI reports and the periodicity of sending them may be configurable (e.g., the duration may be received via configuration information) and/or specified. After that duration (e.g., based on the expiration of the duration), the WTRU may resort to normal (e.g., less frequent) CQI reporting (e.g., CQI reports sent at a longer periodicity as described herein, for example, a periodicity that is being used for an already activated cell). The CQI reports may be sent via the first cell or the second cell. In case CQI reports are sent via the second cell, the WTRU may have to be (e.g., may be) provisioned with UL resources towards the second cell, e.g., in a pre-emptive manner.

The WTRU may be configured with an additional trigger condition that is expected to be fulfilled (e.g., before or immediately after) the triggering conditions for establishing the connection with the target cell, whereupon it may perform the fast CQI reports (e.g., x seconds before the connection establishment time, y m/km before the connection establishment location, etc.). This may enable the network to get information about the quality of the link of the second cell and be able to schedule the WTRU (e.g., schedule immediately) on the second cell immediately after the addition of the second cell. The second cell may be activated immediately after addition (e.g., instead of being added in deactivated state and the WTRU receiving an activation command to start operating with the second cell).

In examples, if it is time (e.g., explicit indication received, trigger condition(s) as described herein have been satisfied, etc.) to start the double connection (e.g., CA operation) towards the two cells (e.g., the first cell and the second cell), the WTRU may start monitoring the PDCCH of the target cell for DL scheduling and UL grants. In examples, if it is time (e.g., explicit indication received, trigger condition(s) as described herein have been satisfied, etc.) to start the double connection (e.g., CA operation) towards the cells (e.g., first cell and second cell), the WTRU may start monitoring the PDCCH of the source cell for DL scheduling and UL grants over the target cell. If it is time to start the double connection (e.g., CA operation) towards the cells (e.g., first cell and second cell), the WTRU may start monitoring the PDCCH of the target cell for DL scheduling and UL grants over the source cell. If it is time (e.g., explicit indication received, trigger condition(s) as described herein have been satisfied, etc.) to start the double connection (e.g., CA operation), the WTRU may send an indication to the network (e.g., RRC message, MAC CE, status report, etc.) either via the first cell or the second cell.

If it is time to tear down the double connection (e.g., explicit indication received, trigger condition(s) as described herein have been satisfied, such as time, location, TA, and/or AoA-based triggers for tearing down the double connection are fulfilled), the WTRU may stop communicating with the source cell (e.g., stop monitoring the PDCCH of the source cell, stop sending any UL signals to the source cell including reference signals, scheduling requests and/or CQI reports, release the resources associated with the target cell, etc.). If it is time to tear down the double connection, the WTRU may stop communicating with the target cell (e.g., stop monitoring the PDCCH of the target cell, stop sending any UL signals to the target cell including reference signals, scheduling requests, and/or CQI reports, release the resources associated with the target cell, etc.).

If it is time (e.g., explicit indication received, trigger condition(s) as described herein have been satisfied, etc.) to terminate the double connection, the WTRU may send an indication to the network (e.g., RRC message, MAC CE, status report, etc.) via the first cell or the second cell (e.g., whichever cell is maintained after the termination of the double connection). Based on the fulfillment (e.g., satisfaction) of the condition to terminate the double connection, if the WTRU detects link quality for the cell to be maintained is below a configured value, the WTRU may report (e.g., measurements and/or explicit indication) to the network prior to or instead of performing the releasing of the concerned connection.

TA pre-compensation and Timing Advance may be provided. The WTRU may be provided with a TA value to apply towards the target cell (e.g., along with the triggering conditions for establishing the second connection). The WTRU may calculate the pre-compensation TA used (e.g., required) for sending UL data towards the second cell based on information of the WTRU's location and/or information broadcasted in system information (e.g., satellite location and/or common delay). The information may be detected from the target satellite and/or cell or included in serving cell's ephemeris. The WTRU may calculate the timing pre-compensation value at a time offset before initiating the connection to the secondary link and/or evaluating triggers to initiate the connection to the target cell. In examples, the WTRU may estimate the timing pre-compensation when one or more triggering conditions (e.g., time, location, TA, and/or AoA-based) have been satisfied. Based on the satisfaction of one or more triggering conditions, the WTRU may report its location (e.g., GNSS) to the serving satellite (e.g., for the network to calculate the timing advance to be applied).

A WTRU associated with a first cell may receive first configuration information. The first configuration information may comprise an indication of a first triggering condition associated with adding a second cell to a connection (e.g., starting CA operation). The WTRU may receive second configuration information. The second configuration information may comprise an indication of a second triggering condition associated with sending a first level of CQI reporting at a first time to the second cell. Based on a determination that the first triggering condition is met, the WTRU may monitor a PDCCH of the first and/or second cell for DL data and/or UL grants associated with the second cell. Based on a determination that the second triggering condition is met, the WTRU may send the first level of CQI reporting at the first time to the second cell. In examples, the first time is before at least one of the following: the third triggering condition being satisfied or receiving a scheduling communication from the second cell.

In examples, based on the determination that the first triggering condition is met, the WTRU may send and/or receive data according to UL and/or DL network scheduled resources towards the first and second cells and/or monitor a third triggering condition (e.g., terminating triggering condition) associated with removing (e.g., disconnecting) the first cell from the connection. Based on a determination that the terminating triggering condition has been met, the WTRU may send a second level of CQI reporting (e.g., CQI reports sent less frequently and/or at a longer periodicity) at a second time to the second cell. The first level of CQI reporting may be associated with more frequent reports (e.g., associated with CQI reports sent at a shorter periodicity) than the second level of CQI reporting. Based on a determination that the second triggering condition is met, the WTRU may send location information associated with the WTRU. The first triggering condition may be a same triggering condition as the second triggering condition. In examples, the first triggering condition and the second triggering condition may be different.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1. A wireless transmit/receive unit (WTRU) associated with a first cell, comprising:
a processor configured to:
send channel quality information (CQI) reports associated with the first cell;
receive an indication of triggering conditions associated with a start of a carrier aggregation (CA) operation with the first cell and a second cell, wherein the triggering conditions comprise:
at least one of a time condition, a timing advance condition, a time/frequency pre-compensation condition, or a location condition, and
a signal level threshold;
determine that the triggering conditions have been met; and
based on the determination that the triggering conditions have been met:
send, via the first cell, CQI reports associated with the second cell, wherein the CQI reports associated with the second cell are sent more frequently than the CQI reports associated with the first cell, and
start the CA operation, wherein during the CA operation:
a connection with the first cell is maintained and a connection with the second cell is initiated, and
a first action via the first cell is performed and a second action via the second cell is performed, wherein the first action is associated with the second action.

2. The WTRU of claim 1, wherein the CQI reports associated with the first cell are sent at a first periodicity and the CQI reports associated with the second cell are sent at a second periodicity, and wherein the second periodicity is shorter than the first periodicity.

3. The WTRU of claim 1, wherein the CQI reports associated with the first cell are sent at a first periodicity and the CQI reports associated with the second cell are sent at a second periodicity, and wherein the second periodicity is shorter than the first periodicity.

4. The WTRU of claim 1, wherein the first action is a reception of a PDCCH transmission via the first cell, wherein the PDCCH transmission indicates a resource associated with the second cell, wherein the resource is for a DL transmission from the second cell or for an UL transmission to the second cell, and wherein the second action comprises a communication with the second cell via the resource.

5. The WTRU of claim 2, wherein the processor is further configured to:
receive an indication to stop the CA operation;
based on the indication, stop the CA operation, wherein the stop of the CA operation includes a disconnection of the WTRU from the first cell; and
send third CQI reports associated with the second cell at a third periodicity, wherein the third periodicity is longer than the second periodicity.

6. The WTRU of claim 1, wherein the processor is further configured to:
receive an indication of terminating triggering conditions associated with the CA operation;
determine that the terminating triggering conditions have been met; and
based on the determination that the terminating triggering conditions have been met, stop the CA operation, wherein the stop of the CA operation includes a disconnection of the WTRU from the first cell.

7. The WTRU of claim 2, wherein the processor is further configured to, based on the CA operation starting, send CQI reports associated with the second cell at a third periodicity, and wherein the third periodicity is longer than the second periodicity.

8. The WTRU of claim 2, wherein the processor is further configured to:
receive configuration information, wherein the configuration information indicates a duration during which CQI reports associated with the second cell are sent at the second periodicity; and
based on expiration of the duration, send third CQI reports associated with the second cell at a third periodicity, wherein the third periodicity is longer than the second periodicity.

9. A method, to be performed by a wireless transmit/receive unit (WTRU), the method comprising:
sending channel quality information (CQI) reports associated with a first cell;
receiving an indication of triggering conditions associated with a start of a carrier aggregation (CA) operation with the first cell and a second cell, wherein the triggering conditions comprise:
at least one of a time condition, a timing advance condition, a time/frequency pre-compensation condition, or a location condition, and
a signal level threshold;
determining that the triggering conditions have been met; and
based on the determination that the triggering conditions have been met:
sending, via the first cell, CQI reports associated with the second cell, wherein the CQI reports associated with the second cell are sent more frequently than the CQI reports associated with the first cell, and
starting the CA operation, wherein during the CA operation:
a connection with the first cell is maintained and a connection with the second cell is initiated, and
a first action via the first cell is performed and a second action via the second cell is performed, wherein the first action is associated with the second action.

10. The method of claim 9, wherein the CQI reports associated with the first cell are sent at a first periodicity and the CQI reports associated with the second cell are sent at a second periodicity, and wherein the second periodicity is shorter than the first periodicity.

11. The method of claim 9, wherein the CQI reports associated with the first cell are sent at a first periodicity and the CQI reports associated with the second cell are sent at a second periodicity, and wherein the second periodicity is shorter than the first periodicity.

12. The method of claim 9, wherein the first action is a reception of a PDCCH transmission via the first cell, wherein the PDCCH transmission indicates a resource associated with the second cell, wherein the resource is for a DL transmission from the second cell or for an UL transmission to the second cell, and wherein the second action comprises a communication with the second cell via the resource.

13. The method of claim 10, further comprising:
receiving an indication to stop the CA operation;
based on the indication, stopping the CA operation, wherein the stop of the CA operation includes a disconnection of the WTRU from the first cell; and
sending third CQI reports associated with the second cell at a third periodicity, wherein the third periodicity is longer than the second periodicity.

14. The method of claim 9, further comprising:
receiving an indication of terminating triggering conditions associated with the CA operation;
determining that the terminating triggering conditions have been met; and
based on the determination that the terminating triggering conditions have been met, stopping the CA operation, wherein the stop of the CA operation includes a disconnection of the WTRU from the first cell.

15. The method of claim 10, further comprising, based on the CA operation starting, sending CQI reports associated with the second cell at a third periodicity, and wherein the third periodicity is longer than the second periodicity.

16. The method of claim 10, further comprising:
receiving configuration information, wherein the configuration information indicates a duration during which CQI reports associated with the second cell are sent at the second periodicity; and
based on expiration of the duration, sending third CQI reports associated with the second cell at a third periodicity, wherein the third periodicity is longer than the second periodicity.
